(19) United States
(12) Patent Application Publication
(10) Pub. No.: US 2006/0158422 A1
(43) Pub. Date: Jul. 20, 2006

(54) Rotating type electric sign board and method for driving thereof

(76) Inventor: Sung-Hyen Ryu, Seoul (KR)

Correspondence Address: PARK LAW FIRM, 3255 WILSHIRE BLVD, SUITE 1110, LOS ANGELES, CA, 90010, US

(21) Appl. No.: 10/559,748

(22) PCT Filed: Oct. 23, 2003
(86) PCT No.: PCT/KR03/02244

§ 371 Date: Dec. 7, 2005

(30) Foreign Application Priority Data
Jun. 7, 2003 (KR) 10-2003-0036588

(51) Int. Cl. G09G 3/34; G09G 3/32

(52) U.S. Cl. 345/110; 345/82

(57) ABSTRACT

A rotary electronic display board and a method for driving the same. The rotary electronic display board switches individual LEDs on or off at their correct positions irrespective of a variation in rotation speed of a drive motor, and correctly and sharply indicates text and image data without using a high-priced encoder, such that it can reduce its own production cost and increase the price competitiveness of a product. The rotary electronic display board includes: a drive motor for rotating a rotary shaft at a predetermined speed; a revolution solid connected to the rotary shaft, which rotates with a predetermined turning radius; an LED array arranged on the revolution solid; an origin pulse generator for generating an origin pulse whenever the revolution solid rotates once; a line pulse generator for calculating a rotation period of the revolution solid using the origin pulse, and generating a plurality of line pulses each having a period corresponding to a division result value which is acquired by dividing the rotation period of the revolution solid by the number of virtual areas separated along the turning radius of the revolution solid; and a controller for generating a control signal to selectively switch on or off the LED array so that desired text and image data is displayed at each line pulse generation time.

### TECHNICAL FIELD

The present invention relates to an electronic display board (also called an electronic sign board), and more particularly to a rotary electronic display board which more clearly displays text and image data by selectively powering on or off an LED (Light Emitting Diode) array, and considerably reduces the cost of manufactured products, and a method for driving the same.

### BACKGROUND ART

Typically, electronic display boards have been adapted to display image or text information. There have been recently proposed a variety of electronic display boards composed of optical fibers, LEDs, and LCDs, etc. Particularly, due to the spread of a large number of high-brightness and multicolor LEDs, there have been commercially developed a variety of electronic display boards, for example, a large-sized electronic display board, an electronic display board for subway guidance, and other electronic display boards for advertisements, etc.

However, most of the aforementioned electronic display boards have been designed to display text or image data using a two-dimensional array. Therefore, the electronic display boards must use a large number of LEDs to clearly display a variety of images or texts, resulting in the increased cost of production. Furthermore, the electronic display boards have disadvantages in that they increase the complexity of their driving circuits and associated control methods and encounter a large amount of power consumption.

In recent times, there have been newly proposed rotary electronic display boards for displaying two-dimensional images using a residual image effect created by rotating one-dimensional array of LEDs. For example, as shown in FIG. 1, the conventional rotary electronic display board rotates around a center shaft 1 by 360°, and contains a revolution solid 5 composed of a plurality of LEDs 3 each selectively switched on or off to indicate text or image data.

For reference, the reference numeral 7 of FIG. 1 indicates a background original board on which text and image data is indicated by the selective on/off operations of the LEDs during a predetermined rotation time of the revolution solid 5, and the reference numeral 9 indicates a drive motor.

In order to drive the aforementioned rotary electronic display board, there has also been newly proposed another rotary electronic display board shown in FIG. 2. Referring to FIG. 2, the rotary electronic display board includes a data entry unit 11 for entering text and image data; a data operation output unit 13 for performing a predetermined operation on the entered text and image data received from the data entry unit 11 to output a turn-on signal of a corresponding LED; a display controller 15 for receiving the output signal of the data operation output unit 13, and generating a control signal for controlling on/off operations of the LED 3 so that desired text and image data can be indicated by the residual image effect; an LED drive 17 for directly controlling the on/off operations of the LED 3 upon receiving the control signal from the display controller 15; a drive motor 9 for rotating the revolution solid 5 connected to the center shaft 1; a phase detector 19 for detecting a phase of the revolution solid 5 according to the number of rotations of the drive motor 9; and a drive motor controller 21 for controlling a rotation speed of the drive motor 9 such that the drive motor 8 can rotate at a predetermined speed upon receiving the phase detection signal from the phase detector 19.

Operations of the above-identified rotary electronic display board of FIG. 2 will hereinafter be described in detail. A user enters his or her desired text or image data to be displayed on the electronic display board using the data entry unit 11. The entry data is transmitted to the data operation output unit 13. The data operation output unit 13 performs a predetermined operation on the received data, and transmits a control signal for controlling a corresponding LED 3 to the display controller 15 in such a way that the text and image data can be displayed by an optical illusion phenomenon caused by the on/off operations of LEDs arranged on the revolution solid 5. In this case, the drive motor 9 receiving a power-supply voltage from a power-supply unit (not shown) rotates at a high speed. The phase detector 19 detects a phase of the revolution solid 5 in response to the rotation of the drive motor 9, and transmits the phase detection signal to the drive motor controller 21. For reference, the sharpness of the text and image data displayed on the electronic display board has been determined based on a rotation speed of the drive motor 9. Upon receiving the phase detection signal from the phase detector 19, the drive motor controller 21 determines whether the drive motor 9 rotates at a predetermined rotation speed. In this case, if it is determined that the current rotation speed of the drive motor 9 is not equal to the predetermined rotation speed, desired text or image data is not correctly displayed on the electronic display board. Therefore, the aforementioned electronic display board m*st use the drive motor controller 21 controlling the drive motor 9 to control the drive motor 9 to maintain the predetermined rotation speed at all times. If it is determined that the drive motor 9 has rotated at the predetermined rotation speed, the display controller 15 outputs a control signal to the LED drive 17. Therefore, the LED drive 17 selectively switches on or off the LEDs 3 during the rotation time of the revolution solid 5 in such a way that the text or image data can be displayed on the electronic display board.

FIG. 3a is a cross-sectional view illustrating a main portion of a third rotary electronic display board. Some parts in the third rotary electronic display board are substantially the same in construction and operation as those in the aforementioned second rotary electronic display board. Referring to FIG. 3a, the third rotary electronic display board includes a revolution solid 5 on which the LEDs 3 are arranged; a drive motor 9 for driving the revolution solid 5; and an encoder 31 for detecting a phase of the revolution solid 5. In this case, the encoder 31a is composed of a disc 31b and a photo-coupler 33c. The disc 31b shown in FIG. 3b is composed of a transparent plastic, and a plurality of shadows arranged at intervals of a predetermined distance are formed in the form of a protractor's angle index in the vicinity of an outer edge of the disc 31b. The encoder 31a outputs a control signal whenever a transparent part of the disc is detected by the photo-coupler 31c.

FIG. 4 is a block diagram illustrating the aforementioned rotary electronic display board. Referring to FIG. 4, the rotary electronic display board includes a controller 41 for controlling overall operations; an encoder 31a for outputting a corresponding control signal to the controller 41 whenever the photo-coupler 31c detects the transparent part of the disc 31b; a data entry unit 11 for entering text and image data to be displayed; a power-supply unit 43 for providing the drive motor 9 with a power-supply voltage upon receiving a control signal from the controller 41; and an LED drive 17 for selectively switching on or off LEDs upon receiving a control signal from the controller 41.

In accordance with the aforementioned rotary electronic display board, the transparent part of the disc 31b is detected whenever the revolution solid 5 and the disc 31b rotate. Whenever the transparent part of the disc 31b is detected, the encoder 31a outputs a control signal to the controller 41. The controller 41 outputs a control signal to the LED drive 17 whenever it receives the control signal from the encoder 31a, such that the LEDs are selectively switched on or off to display desired text and image data on the rotary electronic display board.

However, the aforementioned conventional rotary electronic display board has a disadvantage in that it requires a drive motor controller for maintaining a constant rotation speed of the drive motor because a non-constant rotation speed of the drive motor cannot correctly indicate desired text or image data, resulting in increased cost and size of the electronic display board. In addition, another rotary electronic display board using an encoder containing both a disc and a photo-coupler is very expensive, such that it unavoidably increases the cost of production and reduces the price competitiveness of a product in the market place.

### DISCLOSURE OF THE INVENTION

Therefore, the present invention has been made in view of the above problems, and it is an object of the present invention to provide a rotary electronic display board for correctly indicating text and image data irrespective of a variation in rotation speed of a drive motor, and a method for driving the same.

It is another object of the present invention to provide a rotary electronic display board for correctly and clearly indicating text and image data without using a high-priced encoder, such that it reduces the cost of a product and increases the price competitiveness of the product, and a method for driving the same.

In accordance with one aspect of the present invention, the above and other objects can be accomplished by the provision of a rotary electronic display board apparatus using a residual image effect, comprising: a drive motor for rotating a rotary shaft at a predetermined speed; a revolution solid connected to the rotary shaft, which rotates with a predetermined turning radius; an LED array arranged on the revolution solid; an origin pulse generator for generating an origin pulse whenever the revolution solid rotates once; a line pulse generator for calculating a rotation period of the revolution solid using the origin pulse, and generating a plurality of line pulses each having a period corresponding to a division result value which is acquired by dividing the rotation period of the revolution solid by the number of virtual areas separated along the turning radius of the revolution solid; and a controller for generating a control signal to selectively switch on or off the LED array so that desired text and image data is displayed at each line pulse generation time.

Preferably, the LED array may be composed of a first-colored LED line, a second-colored LED line, and a third-colored LED line, which are spaced apart from each other at a predetermined angle on the basis of the rotary shaft.

Preferably, the LED lines are not always limited to three LED lines (i.e., a red(R)-colored LED line, a green(G)-colored LED line, and a blue(B)-colored LED line), and may also be composed of a plurality of multi-colored LED lines composed of more than three colors if needed. In this case, each angle between adjacent LED lines from among the LED lines may be set to a specific angle indicative of a multiple of a predetermined angle corresponding to the division result value which has been acquired by dividing the turning radius of the revolution solid by the number of virtual lines.

In this way, the aforementioned rotary electronic display board controls the angle between the LED lines to be maintained at the specific angle indicative of the multiple of the predetermined angle corresponding to the division result value, such that the R-colored LED, the G-colored LED, and the B-colored LED are switched on with their brightness levels at their correct timing points in such a way that a clear and sharp color can be created due to the combination of the three colors.

Preferably, the rotary electronic display board may further include a memory for storing data of LEDs to be switched on or off on individual virtual lines so that the text and image data can be displayed. Preferably, data stored in the memory may be read by a DMAC (Direct Memory Access Controller), and may be transmitted to the LED drive. In this case, the data is equal to specific data generated by controlling a brightness level of the LEDs.

In accordance with another aspect of present invention, there is provided a method for driving a rotary electronic display board, comprising the steps of: a) generating an origin pulse whenever a revolution solid rotates once; b) counting a rotation period of the revolution solid using the origin pulse; c) generating a plurality of line pulses each having a period corresponding to a division result value which is acquired by dividing the rotation period of the revolution solid by the number of virtual lines separated along a turning radius of the revolution solid while the revolution solid rotates once; and d) selectively switching on or off a plurality of LEDs at each line pulse generation time, and displaying text and image data.

Preferably, the number of virtual lines separated along the turning radius of the revolution solid may be set to 512 or 1024 according to resolution information of the text and image data to be displayed. Preferably, the rotation period of the revolution solid is calculated by counting a difference between a current origin pulse entry time and a previous origin pulse entry time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a conventional rotary electronic display board, and

FIG. 2 is a block diagram illustrating the conventional rotary electronic display board of FIG. 1;

FIG. 3a is a cross-sectional view illustrating a main portion of another conventional rotary electronic display board, and FIG. 3b is a plan view illustrating the appearance of the disc shown in FIG. 3a;

FIG. 4 is a block diagram illustrating the conventional rotary electronic display board shown in FIG. 3;

FIG. 5 is a cross-sectional view illustrating a main portion of a rotary electronic display board in accordance with a preferred embodiment of the present invention;

FIG. 6 is a block diagram illustrating the rotary electronic display board shown in FIG. 5 in accordance with a preferred embodiment of the present invention;

FIG. 7 is a timing diagram illustrating operations of the rotary electronic display board in accordance with a preferred embodiment of the present invention;

FIG. 8 is a detailed circuit diagram illustrating a brightness level control circuit in accordance with a preferred embodiment of the present invention;

FIG. 9 is a view illustrating an LED array for use in the rotary electronic display board in accordance with a preferred embodiment of the present invention;

FIG. 10 is a cross-sectional view illustrating a main portion of a rotary electronic display board in accordance with another preferred embodiment of the present invention;

FIG. 11 is a view illustrating a text display format displayed on the rotary electronic display board shown in FIG. 10 in accordance with another preferred embodiment of the present invention;

FIG. 12 is a flow chart illustrating a method for driving the rotary electronic display board in accordance with a preferred embodiment of the present invention; and

FIG. 13 is a view illustrating a text display state of the rotary electronic display board in accordance with a preferred embodiment of the present invention.

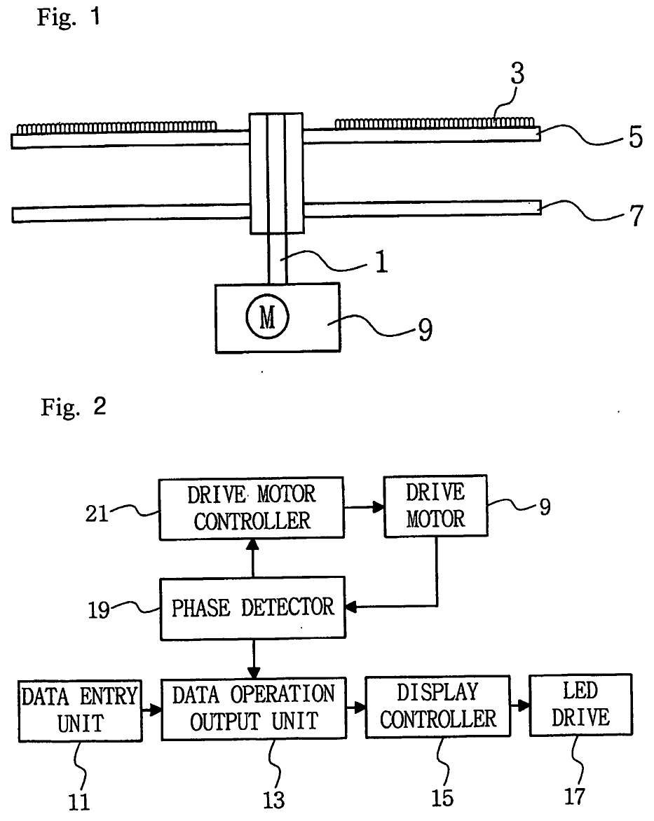

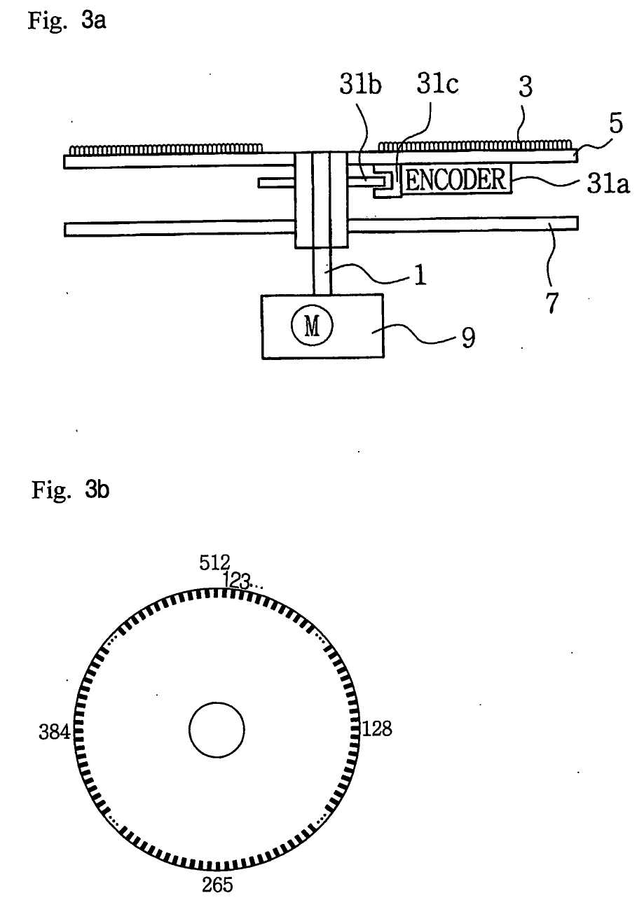

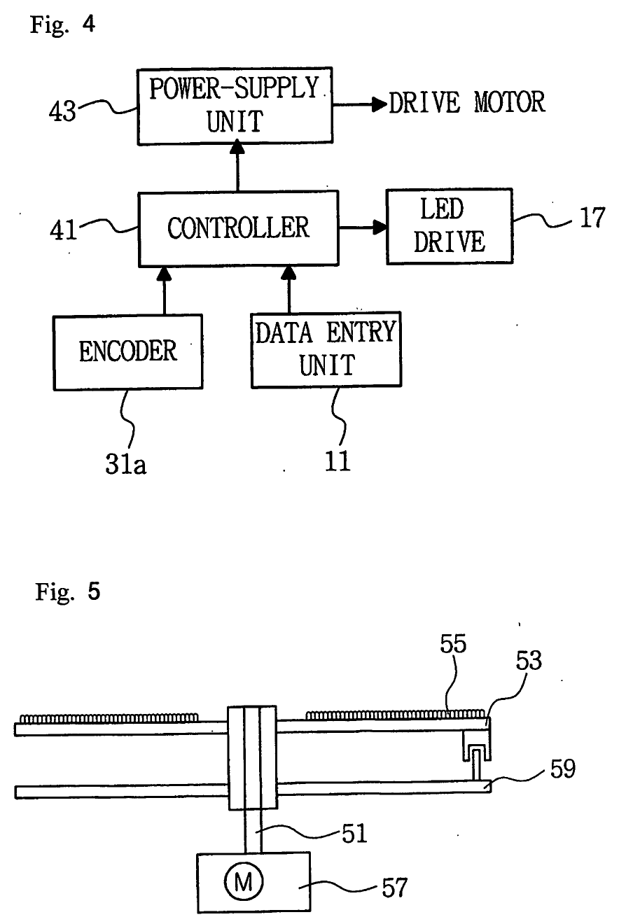

### BEST MODE FOR CARRYING OUT THE INVENTION

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

The rotary electronic display board according to the present invention generates an origin pulse whenever a revolution solid rotates once around a reference point, such that LEDs are selectively switched on or off while the revolution solid on which an LED array is arranged rotates with a predetermined turning radius, and thereby text or image data is displayed on a predetermined position. The rotary electronic display board divides a period of the origin pulse by the number of virtual lines separated along the turning radius, generates a plurality of line pulses each having a period corresponding to the division result value, and selectively switches on or off the LED array whenever the line pulse is generated.

Whereas the conventional rotary electronic display board detects a rotation speed of a drive motor for rotating the revolution solid upon receiving a phase detection signal of the revolution solid from a phase detector, and constantly controls the rotation speed of the revolution solid in such a way that it can indicate text or image data thereon, the inventive rotary electronic display board detects a rotation period of the revolution solid, divides the rotation speed of the revolution solid by the number of virtual lines separated along a turning radius of the revolution solid, generates a plurality of line pulses each having a period corresponding to the division result value, and selectively switches on or off LEDs at each line pulse generation time in such a way that it can correctly indicate text and image data at a specific position. Furthermore, the inventive rotary electronic display board can correctly control on/off times of the LEDs at a specific position inside of the turning radius of the revolution solid using only the origin and line pulses instead of using a high-priced encoder, such that it can clearly and sharply indicate desired text and image data.

Preferred embodiments of the rotary electronic display board according to the present invention will hereinafter be described in detail.

FIG. 5 is a cross-sectional view illustrating a main portion of a rotary electronic display board in accordance with a preferred embodiment of the present invention.

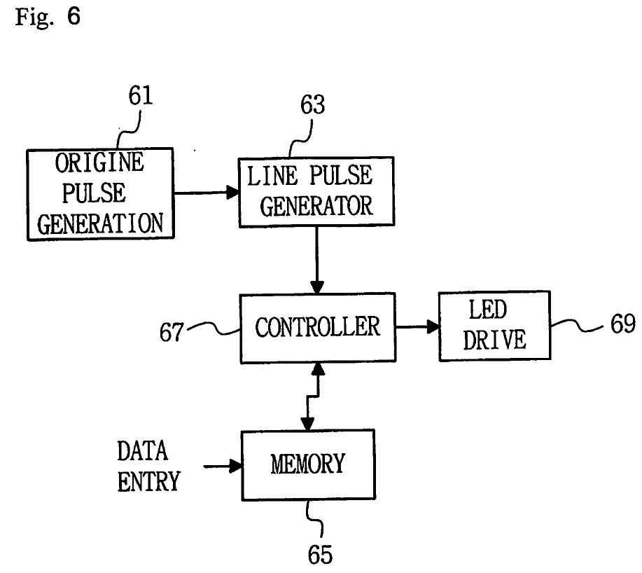

FIG. 6 is a block diagram illustrating the rotary electronic display board shown in FIG. 5 in accordance with a preferred embodiment of the present invention.

Referring to FIGS. 5 and 6, the rotary electronic display board includes a revolution solid 53 for rotating around a rotary shaft 51 with a predetermined turning radius; an LED array 55 composed of a plurality of LEDs, which are arranged on the revolution solid 53, and are selectively switched on or off during a rotation time of the revolution solid 53 in such a way that it can indicate text and image data; and a drive motor 57 for generating a driving power to rotate the revolution solid 53. For reference, the reference numeral 59 of FIG. 5 indicates a background original board on which text and image data is indicated by the residual image effect generated during the rotation time of the revolution solid 53.

The rotary electronic display board according to the present invention further includes: an origin pulse generator 61 for detecting a specific time at which the revolution solid 53 rotates once along the turning radius, and generating an OP (Origin Pulse) whenever the revolution solid 53 rotates once; a line pulse generator 63 for calculating a rotation period of the revolution solid 53 using a generation period of the OP generated from the origin pulse generator 61, dividing the rotation period of the revolution solid 53 by the number of virtual lines separated along the turning radius of the revolution solid 53, and generating a plurality of line pulses (LPs) each having a period corresponding to the division result value; a memory 65 for storing data of LEDs to be selectively switched on or off on each virtual line to indicate text and image data; a controller 67 for controlling overall operations to operate the electronic display board, reading data stored in the memory 65, and transmitting the read data to an LED drive; and an LED drive 69 for selectively switching on or off the LEDs upon receiving a control signal from the controller 67.

Furthermore, the rotary electronic display board further includes a power-supply unit for providing the drive motor 57 with a power-supply voltage; and a data entry unit for entering text and image data to be displayed.

The controller 67 further includes a DMAC (Direct Memory Access Controller). In this case, the DMAC reads data of LEDs to be switched on or off at a corresponding time whenever it receives the line pulse, and transmits the read data to the LED drive 69.

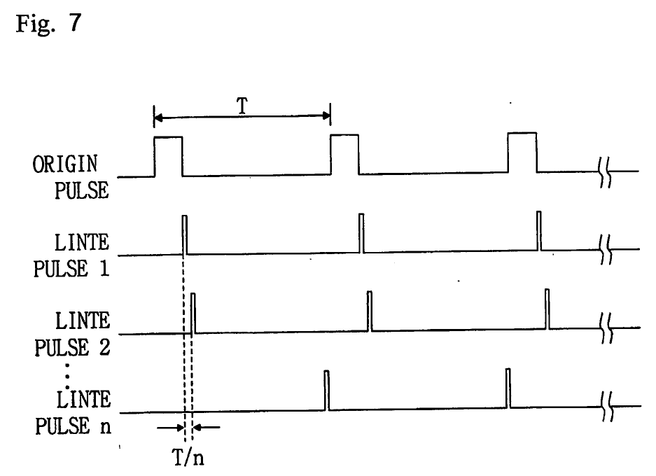

Operations of the aforementioned rotary electronic display board will hereinafter be described with reference to FIG. 7.

Referring to FIG. 7, the origin pulse generator 61 generates the OP whenever the revolution solid 53 rotates once. If the OP generated from the origin pulse generator 61 is transmitted to the line pulse generator 63, the line pulse generator 63 counts a difference between a current origin pulse time and a previous origin pulse time in such a way that it can calculate one rotation period of the revolution solid 53.

Thereafter, the line pulse generator 63 generates a plurality of line pulses LP1, LP2, . . . , LPn each having a specific period corresponding to the division result value which is generated by dividing the rotation period of the revolution solid 53 by the number of virtual lines separated along the turning radius of the revolution solid 53. For example, provided that the virtual line is divided into 512 lines along the turning radius of the revolution solid 53, the line pulse generator 63 generates 512 line pulses at intervals of a predetermined period during the rotation period of the revolution solid 53.

The line pulse generated from the line pulse generator 63 is transmitted to the controller 67. The DMAC (Direct Memory Access Controller) contained in the controller 67 reads data of LEDs to be switched on or off from the memory 65 whenever it receives the line pulse, and transmits the read data to the LED drive 69. The LED drive 69 controls on/off operations of corresponding LEDs in response to data received from the DMAC, and indicates text and image data by selectively switching on or off the LEDs during the rotation time of the revolution solid 53. In this case, the data is generated by controlling a brightness level of individual LEDs, such that the brightness level of the LEDs can be controlled using the data value.

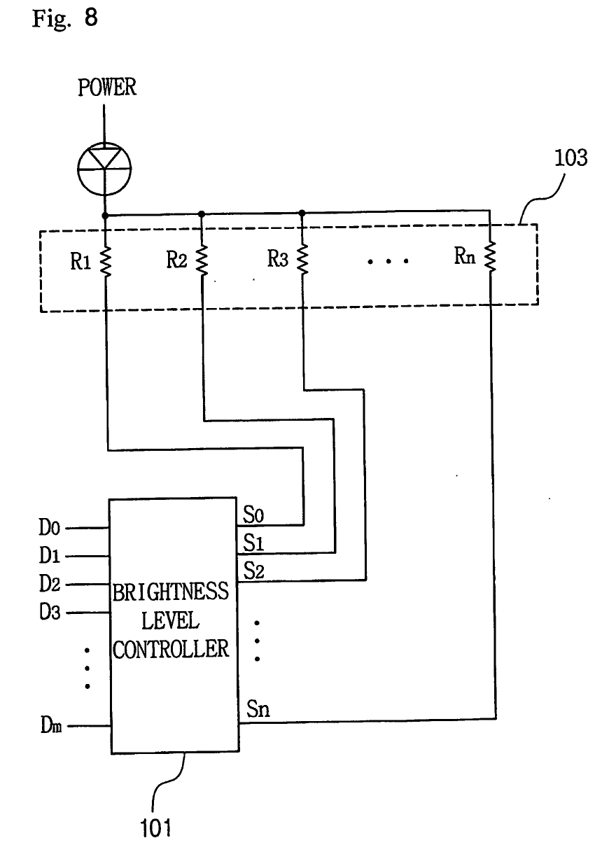

FIG. 8 is a detailed circuit diagram illustrating a brightness level control circuit in accordance with a preferred embodiment of the present invention. The brightness level control circuit includes a brightness level controller 101 and a resistor array 103. Data applied to the brightness level controller 101 is the same as the above brightness-level controlled data. In more detail, referring to FIG. 8, upon receiving n-bits of data from the DMAC, the brightness level controller 101 selects M resistors from among N resistors in order to switch on the LEDs at a predetermined brightness level corresponding to the n-bits of data. A current signal controlled by the sum of the selected resistor values is transmitted to the LEDs, such that the LEDs are switched on at the predetermined brightness level corresponding to the data transmitted from the DMAC to the brightness level controller 101. In this case, N resistors have different resistances, and are arranged to enable different resistances to be sequentially increased or reduced.

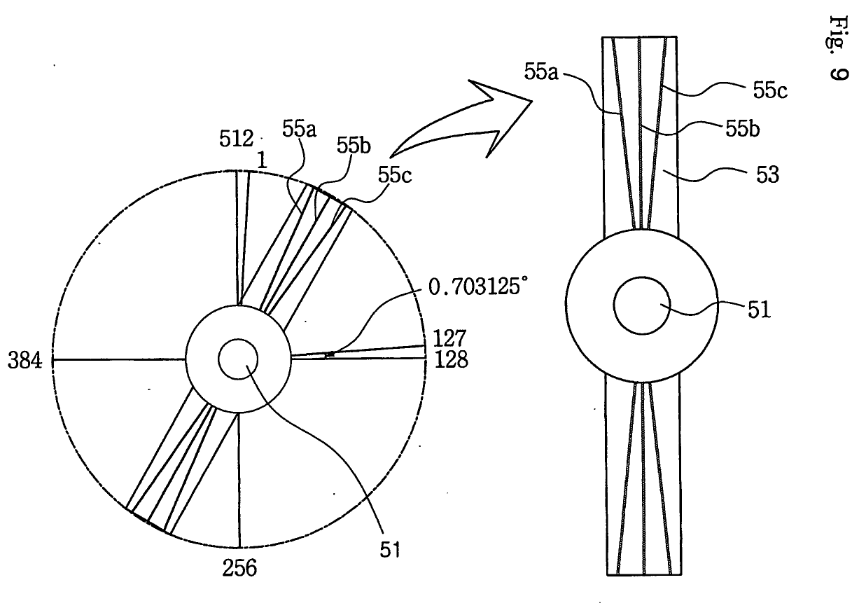

FIG. 9 is a view illustrating an LED array for use in the rotary electronic display board in accordance with a preferred embodiment of the present invention. Three LED lines 55a, 55b and 55c composed of Red(R), Green(G), and Blue(B) colors, respectively, are arranged on the revolution solid 53 with a predetermined angle on the basis of the rotary shaft 51. In this case, the angle between the LED lines adjacent to each other is determined by the number of virtual lines separated along the turning radius of the revolution solid 53. Provided that 512 virtual lines are separated along the turning radius, the angle between the adjacent virtual lines is set to 0.703125° acquired by dividing 360° (i.e., the turning radius of the revolution solid 53) by 512 (i.e., the number of virtual lines), and there is a need for the angle among the R/G/B LED lines to satisfy the set angle of 0.703125°. However, the angle among the R-LED line 55a, the G-LED line 55b, and the B-LED line 55c arranged on the revolution solid 53 must be higher than 0.703125° in light of the size of the individual LEDs. Practically, in the case of arranging individual LED lines spaced apart from each other at a predetermined angle on the revolution solid 53, it is preferable for each angle among the LED lines 55a, 55b and 55c to be set to a specific angle indicative of a multiple of 0.703125°, for example, 1.40625°, 2.109375°, and 2.8125°, . . . (=0.703125×M, M=natural number).

In this way, the rotary electronic display board controls the angle among adjacent LED lines to be set to the multiple of 0.703125° acquired by dividing the turning radius 360° of the revolution solid 53 by the number of virtual lines (i.e., 512 lines), such that it can sequentially switch on the above-described R/G/B LED lines on a specific position at a correct time, resulting in clearly and sharply indicating text and image data of a desired color.

Furthermore, although the above-described rotary electronic display board has disclosed only three LED lines (i.e., R/G/B LED lines) for illustrative purposes, it may also use a plurality of multi-color LED lines according to resolution information, instead of using the above three-colors LED lines, if needed.

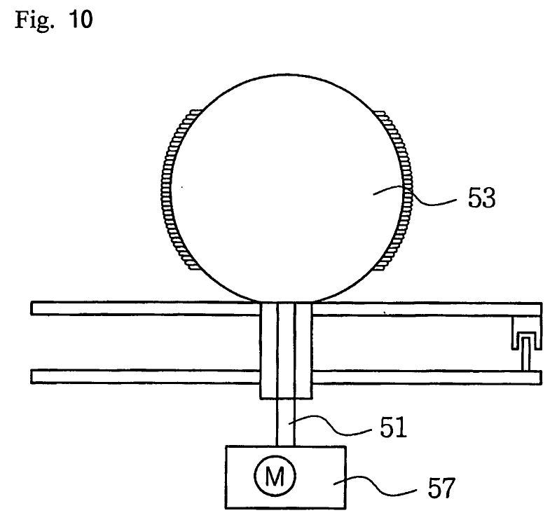

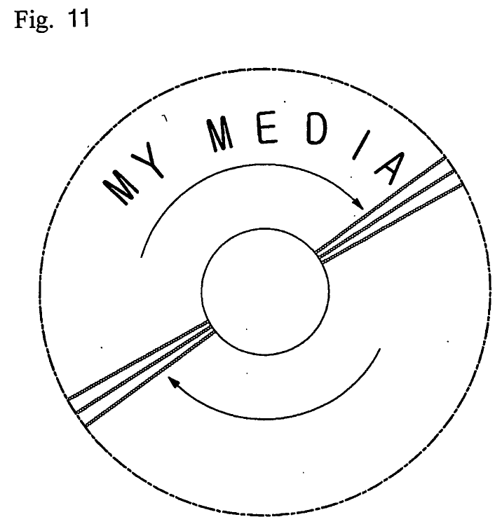

It should also be noted that the revolution solid 53 is configured in the form of a variety of shapes, for example, a bar and a sphere, etc. In more detail, although the revolution solid 53 of FIG. 9 is configured in the form of a bar, it can also be configured in the form of a sphere as shown in FIG. 10 if needed. The display format when the revolution solid 53 is configured in the form of the sphere is shown in FIG. 11. In this case, the rotary electronic display board detects a rotation period of the revolution solid 53, generates an origin pulse whenever the revolution solid 53 rotates once, divides the period of the origin pulse by the number of virtual lines separated along the turning radius of the revolution solid, generates a plurality of line pulses each having a period corresponding to the division result value, and selectively switches on or off the LED array whenever the line pulse is generated. The above-described operations of the rotary electronic display board are the same as in the bar-shaped revolution solid 53.

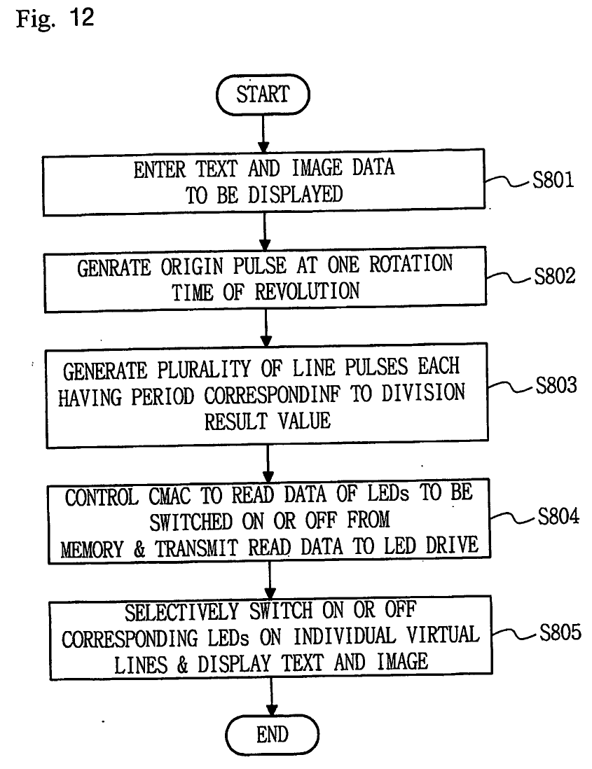

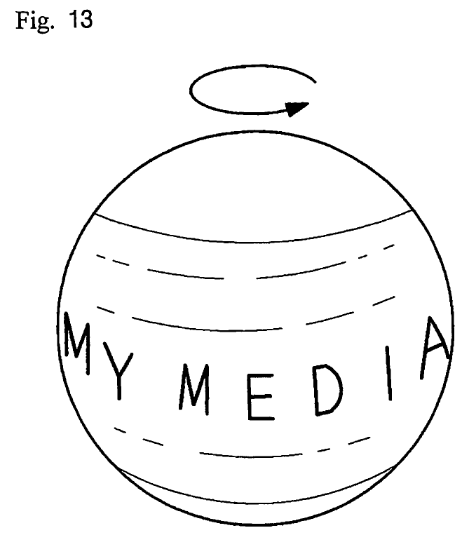

A method for driving the rotary electronic display board will hereinafter be described with reference to FIG. 12. FIG. 12 is a flow chart illustrating a method for driving the rotary electronic display board in accordance with a preferred embodiment of the present invention.

Referring to FIG. 12, a user enters his or her desired text and image data to be displayed on the rotary electronic display board at step S801. In more detail, the rotary electronic display board controls the DMAC of the controller 67 to set up an address of the memory 65 in association with LEDs to be switched on or off on a corresponding virtual line corresponding to desired text and image data. Thereafter, the revolution solid 53 rotates at a predetermined speed upon providing the drive motor 57 with a power-supply voltage. In this case, the origin pulse generator 61 generates an origin pulse whenever the revolution solid 53 rotates once around a reference point at step S802.

The origin pulse generated from the origin pulse generator 6 is transmitted to the line pulse generator 63. The line pulse generator 63 counts a difference between a current origin pulse time and a previous origin pulse time in such a way that it can calculate a period of the revolution solid 53. The line pulse generator 63 generates a plurality of line pulses each having a specific period corresponding to the division result value which is acquired by dividing the rotation period of the revolution solid 53 by the number of virtual lines separated along the turning radius of the revolution solid 53, at step S803.

The line pulse generated from the line pulse generator 63 is transmitted to the controller 67. The DMAC contained in the controller 67 reads data of LEDs to be switched on or off from the memory 65 at each line pulse reception time, and outputs the read data to the LED drive 69 at step S804.

Finally, the LED drive 69 selectively switches on or off corresponding LEDs arranged on individual virtual lines upon receiving the data from the controller 67 at step S805.

Therefore, as shown in FIG. 13, corresponding LEDs positioned on individual virtual lines separated along the turning radius are selectively switched on or off during the rotation time of the revolution solid 53, such that desired text and image data can be displayed on the rotary electronic display board due to the residual image effect.

### INDUSTRIAL APPLICABILITY

As apparent from the above description, the rotary electronic display board and a method for driving the same according to the present invention can simplify an overall circuit configuration because there is no need for an additional drive motor controller for constantly maintaining a rotation speed of the drive motor or for a high-priced encoder to be used, resulting in a reduced cost of production and an increased price competitiveness of a product.

Furthermore, the rotary electronic display board detects a rotation period of the revolution solid using an origin pulse, divides the rotation period of the revolution by the number of virtual lines separated along a turning radius of the revolution solid, controls LEDs to be switched on or off at their correct positions using line pulses each having a period equal to the division result value, resulting in the creation of clear and sharp text and image data.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A rotary electronic display board apparatus, comprising:
a drive motor for rotating a rotary shaft at a predetermined speed;
a revolution solid connected to the rotary shaft, which rotates with a predetermined turning radius;
an LED array arranged on the revolution solid;
an origin pulse generator for generating an origin pulse whenever the revolution solid rotates once;
a line pulse generator for calculating a rotation period of the revolution solid using the origin pulse, and generating a plurality of line pulses each having a period corresponding to a division result value which is acquired by dividing the rotation period of the revolution solid by the number of virtual areas separated along the turning radius of the revolution solid; and
a controller for generating a control signal to selectively switch on or off the LED array so that desired text and image data is displayed at each line pulse generation time.

2. The apparatus as set forth in claim 1, further comprising:
an LED drive for selectively switching on or off LEDs upon receiving the control signal from the controller.

3. The apparatus as set forth in claim 1, wherein the LED array is composed of a plurality of multi-color LED lines which are spaced apart from each other at a predetermined angle on the basis of the rotary shaft.

4. The apparatus as set forth in claim 3, wherein the LED lines are composed of red(R), green(G), and blue(B)—colored LED lines, respectively.

5. The apparatus as set forth in claim 3, wherein:
each angle among the LED lines is set to a specific angle indicative of a multiple of a predetermined angle corresponding to the division result value which has been acquired by dividing the turning radius of the revolution solid by the number of virtual lines.

6. The apparatus as set forth in claim 1, further comprising:
a memory for storing data of LEDs to be switched on or off on individual virtual lines so that the text and image data can be displayed.

7. The apparatus as set forth in claim 1, further comprising:
a brightness level controller for controlling a brightness level of individual LEDs contained in the LED array.

8. The apparatus as set forth in claim 1, wherein the controller further includes:
a DMAC (Direct Memory Access Controller) for reading data of LEDs to be selectively switched on or off on the virtual lines from a memory, and transmitting the read data to an LED drive.

9. The apparatus as set forth in claim 1, wherein the revolution solid is configured in the form of either one of a circle, curve, and a straight bar.

10. The apparatus as set forth in claim 6, wherein the data is equal to specific data generated by controlling a brightness level of the LEDs.

11. A method for driving a rotary electronic display board, comprising the steps of:
a) generating an origin pulse whenever a revolution solid rotates once;
b) counting a rotation period of the revolution solid using the origin pulse;
c) generating a plurality of line pulses each having a period corresponding to a division result value which is acquired by dividing the rotation period of the revolution solid by the number of virtual lines separated along a turning radius of the revolution solid while the revolution solid rotates once; and
d) selectively switching on or off a plurality of LEDs at each line pulse generation time, and displaying text and image data.

12. The method as set forth in claim 11, wherein the step (a) for counting the rotation period of the revolution solid includes the step of:
counting a difference between a current origin pulse entry time and a previous origin pulse entry time so that the rotation period of the revolution solid can be recognized.
